(19) United States
(12) Patent Application Publication
(10) Pub. No.: US 2022/0269904 A1
(43) Pub. Date: Aug. 25, 2022

(54) NETWORK STATUS CLASSIFICATION

(71) Applicant: Telefonaktiebolaget LM Ericsson (publ), Stockholm (SE)

(72) Inventors: Aakash AGARWAL, Rajasthan (IN); Prasenjeet ACHARJEE, Bangalore (IN); Philipp FRANK, Madrid (ES)

(21) Appl. No.: 17/625,490

(22) PCT Filed: Jul. 9, 2019
(86) PCT No.: PCT/SE2019/050679

§ 371 Date: Jan. 7, 2022

(51) Int. Cl. G06K 9/62; H04W 24/08; H04W 16/22

(52) U.S. Cl. CPC G06K 9/6256; G06K 9/6267; H04W 24/08; H04W 16/22

(57) ABSTRACT

A method is disclosed of training a network status classification model. The method includes obtaining measurements of network parameters of a communications network, converting the measurements into a plurality of first images representing the measurements and training a deep convolutional generative adversarial network, DCGAN, with the first images. The method also includes generating a plurality of second images representing artificial measurements of the network parameters using the DCGAN, and training a network status classification model with the plurality of second images.

### TECHNICAL FIELD

Examples of the present disclosure relate to network status classification, and in particular examples to training a network status classification model.

### BACKGROUND

It is useful in communication networks such as wireless communication networks to be able to reliably detect and identify issues or anomalies within the network, and in some cases to then dynamically provide capacity required to satisfy end-user demand. For example, a shortage of capacity of a cell in a network may cause poor end-user experience in terms of long webpage download times or video stream freezing. On the other hand, an over-provisioning of cell capacity may result in under-utilized cell resources and thus operational inefficiencies.

Currently, there are different techniques used to analyze cell traffic load for various radio access network (RAN) technologies. Examples of these techniques may apply a set of rule-based instructions combined with pre-determined thresholds for different performance measurement metrics. These rules and thresholds are based on human observations and a small sampled data set. Furthermore, the number of considered performance measurement metrics to identify cell load issues for these techniques is typically small and consist only of common metrics.

Wireless communications networks generate significant amounts of data. This data may require categorizing before it can be used to train a machine learning system that could be used to monitor a network. In addition, data sets may be noisy, incomplete and/or incorrectly normalized or labelled, or may be proprietary. Finally, in the case of wireless communications networks, existing historical data may comprise representations of network data that were not built for machine learning purposes.

To label any historical RAN data, such as for example anomaly data (data that is produced in the case of an anomaly in the network), a network domain expert needs to manually label the data as representing an anomaly from normal network behaviour, and label different types of anomalies. The labelled data may be applied to a supervised machine learning algorithm, which may then be used to classify various cell anomalies. However, manual analysis of the large amount of historical data and associated metrics is inefficient and practically not feasible. Manual analysis is also not sustainable as this method is subject to individual personnel knowledge and experience, which can result in inconsistencies and rendering the process non-scalable.

### SUMMARY

One aspect of this disclosure provides a method of training a network status classification model. The method comprises obtaining measurements of network parameters of a communications network, converting the measurements into a plurality of first images representing the measurements and training a deep convolutional generative adversarial network, DCGAN, with the first images. The method also comprises generating a plurality of second images representing artificial measurements of the network parameters using the DCGAN, and training a network status classification model with the plurality of second images.

Another aspect of this disclosure provides apparatus for training a network status classification model. The apparatus comprises a processor and a memory. The memory contains instructions executable by the processor such that the apparatus is operable to obtain measurements of network parameters of a communications network, convert the measurements into a plurality of first images representing the measurements, train a deep convolutional generative adversarial network, DCGAN, with the first images, generate a plurality of second images representing artificial measurements of the network parameters using the DCGAN, and train a network status classification model with the plurality of second images.

A further aspect of this disclosure provides apparatus for training a network status classification model. The apparatus is configured to obtain measurements of network parameters of a communications network, convert the measurements into a plurality of first images representing the measurements, and train a deep convolutional generative adversarial network, DCGAN, with the first images. The apparatus is also configured to generate a plurality of second images representing artificial measurements of the network parameters using the DCGAN, and train a network status classification model with the plurality of second images.

### BRIEF DESCRIPTION OF THE DRAWINGS

For a better understanding of examples of the present disclosure, and to show more clearly how the examples may be carried into effect, reference will now be made, by way of example only, to the following drawings in which:

FIG. 1 is a flow chart of an example of a method 100 of training a network status classification model;

FIG. 2 shows an example of a greyscale image representing measurements of network parameters of a communications network;

FIG. 3 shows an example of a Deep Convolution Generative Adversarial Network (DCGAN);

FIG. 4 is an example of an algorithm that may be implemented by a DCGAN; and

FIG. 5 is a schematic of an example of apparatus for training a network status classification model.

### DETAILED DESCRIPTION

The following sets forth specific details, such as particular embodiments or examples for purposes of explanation and not limitation. It will be appreciated by one skilled in the art that other examples may be employed apart from these specific details. In some instances, detailed descriptions of well-known methods, nodes, interfaces, circuits, and devices are omitted so as not obscure the description with unnecessary detail. Those skilled in the art will appreciate that the functions described may be implemented in one or more nodes using hardware circuitry (e.g., analog and/or discrete logic gates interconnected to perform a specialized function, ASICs, PLAs, etc.) and/or using software programs and data in conjunction with one or more digital microprocessors or general purpose computers. Nodes that communicate using the air interface also have suitable radio communications circuitry. Moreover, where appropriate the technology can additionally be considered to be embodied entirely within any form of computer-readable memory, such as solid-state memory, magnetic disk, or optical disk containing an appropriate set of computer instructions that would cause a processor to carry out the techniques described herein.

Hardware implementation may include or encompass, without limitation, digital signal processor (DSP) hardware, a reduced instruction set processor, hardware (e.g., digital or analogue) circuitry including but not limited to application specific integrated circuit(s) (ASIC) and/or field programmable gate array(s) (FPGA(s)), and (where appropriate) state machines capable of performing such functions.

Supervised learning algorithms may be useful for example as part of Artificial Intelligence (AI) powered Network Design and Optimization (NDO). In an example, there are three major components for network optimization: a classifier, a recommender, and an implementation engine/feedback loop. The classifier system automatically detects and classifies different issues in the network, whereas the recommender system provides detailed root-cause analysis and potential actions to be implemented in the network. These recommendations may be implemented and verified through the resulting network performance and fed back to the classifier system. Thus, for example, a reliable classifier that is able to analyse data and provide an accurate classification of a network status (e.g. normal operation, anomalous operation, and/or type of anomaly) is a useful component.

Network datasets for supervised training are in general very imbalanced due to the fact that some network issues occur more frequently than others. Obtaining sufficient samples of different network anomalies is very challenging, however crucial for increasing the prediction accuracy.

Embodiments of the present disclosure provide a method of training a network status classification model, such as for example a model that is able to analyse network performance data and to classify the status of the network (e.g. normal operation, anomalous operation, and/or type of anomaly). In an example, a proposed method consists of several components to classify various types of anomalies that can occur in a radio access network (RAN). In some examples, a method comprises generating artificial or synthetic data using a deep convolutional generative adversarial network (DCGAN), and using the artificial data to train a network status classification model.

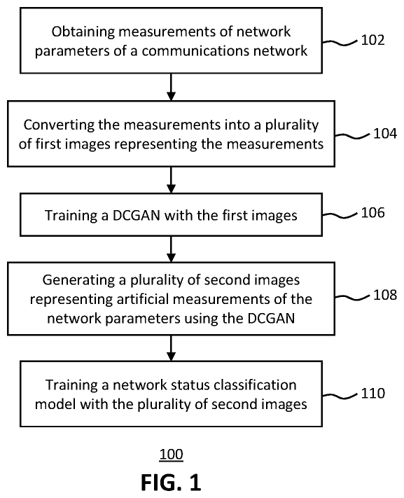

FIG. 1 is a flow chart of an example of a method 100 of training a network status classification model. The method comprises, in step 102, obtaining measurements of network parameters of a communications network. The network parameters may comprise, for example, any parameters, performance indicators, key performance indicators etc. that may indicate the performance of the network and/or one or more components or nodes in the network. Examples include a PUSCH interference level, PUCCH interference level, an average Channel Quality Indicator, CQI, and a rate of a CQI below a predetermined value received at a node in the network. These example parameters may relate to one or more nodes or cells in a communications network. For example, parameters may include multiple PUSCH interference levels experienced at respective nodes or cells in a network. In some examples, measurement is prepared and treated for missing data, outliers, null and erroneous data etc. using established techniques that are used to convert the raw data into a clean data set. In some examples, the measurement data set is normalized (e.g. with capped outliers) to transform the raw measurement data values into values between two particular values, such as 0 and 1, with a higher value signifying for example more impact of that network parameter on the network status or on the status of a particular node or cell.

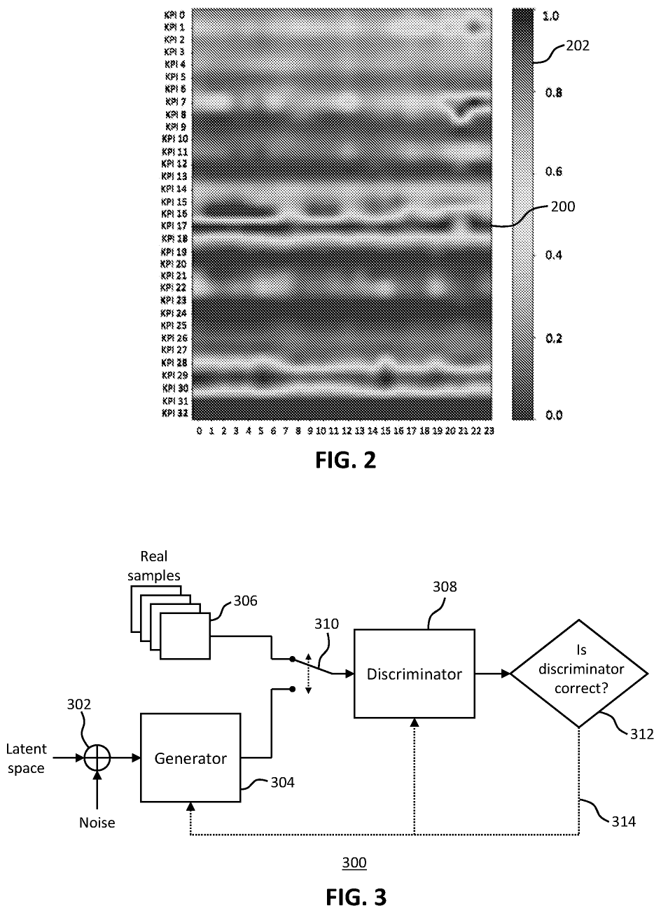

Step 104 of the method 100 comprises converting the measurements into a plurality of first images representing the measurements. This may be done in any suitable manner. For example, a two-dimensional image may have data arranged as pixels with time on the x-axis and parameter on the y-axis. The value (e.g. greyscale value) of the pixel may represent the value of the data. FIG. 2 shows an example of a greyscale image 200 representing measurements of network parameters of a communications network. Time is represented on the x-axis, increasing from left to right, and the y-axis represents the particular parameter, which in this example comprises KPIs (key performance indicators) 1 to 32. A scale 202 is shown to illustrate the data values represented in the image 200. The values range from 0.0 to 1.0, indicating that the measurements represented in the image 200 have been normalised. In one example, in an image with 8 bits per pixel, a pixel value of 0 may represent a normalised measurement of 0.0, whereas a pixel value of 255 may represent a normalised measurement of 1.0. It is noted that the example image 200 representing measurements of network parameters is merely an example, and any suitable method of representing measurements as an image may be used (including, in some examples, combining measurements of network parameters).

In a particular example, images may be generated as follows. Measurements of network parameters (e.g. performance metrics or KPIs) for a certain period, such as for example a 24 hour window, are taken and are transformed into a multi-dimensional representation of various performance metrics and time to capture the multi-spatial relationships between them. In one example, an unsupervised learning method called T-distribution Stochastic Nearest Embedding (T-SNE) is applied on the processed data to apply dimensionality reduction to identify the key features or characteristics (latent space) of the different network cell issues. In an example, this resulted in a reduction of more than 720 dimensions (30 performance metrics×24 hours). Subsequently, the data is then transformed into an image representation of the network performance. The network parameters, performance metrics or KPIs represent one dimension in the image (e.g the x-axis) and the other dimension (e.g. y-axis) represents time. In some examples, the granularity of the measurements in time can be flexibly defined from minutes to hours, days, up to weeks depending on the desired time window observation for the network issue patterns. Each pixel of the resulting first image may correspond to a specific value (or impact on the network or node/cell) at a certain time instance, enabling capture of the multi-spatial relation between network parameters and time.

The method 100 continues at step 106, comprising training a deep convolutional generative adversarial network, DCGAN, with the first images. A DCGAN is described in reference [1] and may be trained using images to generate further images that are similar to those used to train the DCGAN, but may include differences. In step 108, the method comprises generating a plurality of second images representing artificial measurements of the network parameters using the DCGAN. Thus, in some examples, the DCGAN may generate a large number of second images representing the artificial measurements compared to the number of first images representing real measurements of the network parameters. Step 110 of the method 100 comprises training a network status classification model with the plurality of second images. The network classification model may comprise, for example, an image recognition model. In some examples, any suitable network status classification model may be used, which may subsequently be able to classify further images based on further real measurements of network parameters. In some examples, the network status classification model may comprise or include a convolutional neural network (CNN).

An example of a DCGAN will now be described. A Deep Convolution Generative Adversarial Networks (DCGAN) is a deep neural net architecture comprised of 2 nets pitting one against the other to create synthetic data. A Generative Adversarial Network (GAN) or DCGAN consists of 2 models, a generator model and a discriminator model. The discriminator model is a classifier that determines whether a given image looks like a real image from a set of real images (e.g. images representing real measurements of network parameters, such as first images) or like an artificially created image (e.g. an image representing artificial measurements of network parameters, such as second images). This is for example a binary classifier that may take the form of a normal convolutional neural network (CNN). The generator model takes random input values and transforms them into images, for example through a deconvolutional neural network. Over the course of many training iterations, the weights and biases in the discriminator and the generator may be trained through feedback or backpropagation. The discriminator may learns to tell real images apart from artificially generated images created by the generator. At the same time, the generator may use feedback from the discriminator to learn how to produce convincing images that the discriminator can't distinguish from real images.

FIG. 3 shows an example of a DCGAN 300. Noise is added to latent space at node 302. The resulting data is provided to generator (G) 304 which generates artificial images (e.g. images representing artificial measurements). The artificial images or real images 306 are selectively provided to discriminator (D) 308 via switch 310. The discriminator 308 makes a decision as to whether an image is real or artificial. Block 312 determines whether the decision is correct, and the result is fed back via feedback path 314 to the generator 304 and discriminator 308, which may both use the result to improve their particular function. FIG. 4 is an example of an algorithm that may be implemented by a DCGAN, such as for example the DCGAN 300 shown in FIG. 3.

In some examples, each of the first images is associated with a respective network status of the network from a plurality of network statuses. The network status may also be referred to as a label. The network status or label may for example indicate the state of the network (e.g. normal, anomalous) when the measurements represented by the first image were collected. In some examples, the network status may also indicate a particular anomaly or fault in the case of anomalous network behaviour. Thus, in some examples, generating the plurality of second images may comprise generating a respective artificial network status associated with each of the second images. That is, each of the plurality of second images may be associated with an artificial network status. In some examples, each second image may be generated such that it is similar to a first image with the same network status.

Regarding evaluation of the DCGAN, or of second images generated by the DCGAN, previous examples mainly involve a subjective visual evaluation of images synthesized by GANs. However, in many cases, such as for example for images representing measurements of network parameters, it is impractical to accurately judge the quality of “artificial” images representing artificial measurements with a subjective visual evaluation, for example due to the large number of such images and/or the non-intuitive nature of the images. Some metrics such as Inception score (IS) and Frechet Inception distance (FID) are suggested. Inception score (IS) measures the quality of a generated (artificial) image by computing the KL divergence between the (logit) response produced by this image and the marginal distribution, using an Inception network trained on ImageNet. In other words, Inception score does not compare samples with a target distribution and is limited to quantifying the diversity of generated samples. Frechet Inception distance (FID) compares Inception activations (responses of the penultimate layer of the Inception network) between real and generated images. This comparison however approximates the activations of real and generated images as Gaussian distributions, computing their means and covariances, which are too crude to capture subtle details. Both these measures rely on an ImageNet-pretrained Inception network, which is unsuitable for use with data sets such as measurements of network parameters of a communications network.

Proposed herein are alternative examples of evaluation of the DCGAN. In some examples, after training the DCGAN, the method 100 comprises evaluating the DCGAN. In an example, evaluating the DCGAN comprises training a further network status classification model with the plurality of second images. The further network status classification model may be the same as the network status classification model trained in step 110 of the method 100, but only trained with the plurality of second images (or a subset of them). The evaluation also includes providing one or more of the first images to the further network status classification model to provide, for each of the one or more first images, a respective estimated network status of the network. Then, the network status and the estimated network status associated with each of the one or more first images may be compared. If these are the same for a first image, then the further network status classification model has estimated the network status of the first image correctly. The proportion of correctly estimated status for the one of more first image may for example provide a measure of the accuracy of the second images and thus the DCGAN (e.g. a measure of how accurately the model, trained with images associated with artificial data, can correctly classify images associated with real data).

In some examples, additionally or alternatively, after training the DCGAN, the method 100 comprises evaluating the DCGAN in another manner. This comprises training a further network status classification model with the plurality of first images. Next, the further network status classification model is provided with one or more of the second images to the further network status classification model to provide, for each of the one or more second images, a respective estimated artificial network status of the network. The artificial network status and the estimated artificial network status associated with each of the one or more second images is then compared, which may give another measure of the accuracy of the second images and thus the DCGAN.

In particular examples, a first evaluation metric (EvalDiversity) trains a classifier (i.e. network status classification model) using generated synthetic images (e.g. second images) and measures its performance on real images (e.g. first images). This evaluates the diversity and realism of generated synthetic images. A second evaluation metric (EvalDistributionAccuracy) trains a classifier on real images and measures its performance on generated synthetic images. This measures how close is the generated data distribution to the actual data distribution. A third evaluation metric (EvalMergedModelTestMergedData) trains a classifier on a merged data set (both real and synthetic images) and measures its performance on merged data. This further certifies the diversity of the images generated by the deep generative model. A fourth evaluation metric (EvalMergedModelTestRealData) trains a classifier on a merged data set comprising subsets of real images and artificial images (e.g. 50% of real images and 50% of synthetic, artificial images). Evaluation is done only on real images not used for training the evaluation classifier. This evaluates whether adding generated data improves the classifier trained on original data. Embodiments of the invention may use any one or more, or all, of these evaluation metrics to evaluate the DCGAN.

In some examples, a saturation test may be performed on the network status classification model. For example, the saturation test may estimate the maximum sample size of images (real and/or generated images) used to train the model, after which there is no improvement in the performance (e.g. accuracy or reliability) of the model, or no significant improvement. The sample size of generated data is increased up to the saturation point, it will improve the classifier model quality because the generated images will be diverse based on the distribution learned by deep generative model. After saturation point, the classifier accuracy may deteriorate in some examples. Thus, in some examples, once the saturation point is known (e.g. experimentally), the number of images used to train the model may not exceed the saturation point.

In some examples, at least one of the plurality of network statuses comprises a network fault status (or a network anomaly status). In some examples, there may be different fault or anomaly statuses for different faults or anomalies.

In some examples, the method 100 comprises classifying a status of the network based on further measurements of the network parameters. For example, once the DCGAN and network status classification model have been trained, further real measurements of the network parameters may be taken and provided to the network status classification model, and the model may be able to classify the network status in real time based on the further measurements. Classifying the status of the network may in some examples comprise converting the further measurements into a further image representing the further measurements, and providing the further image to the network status classification model to provide a status of the network. The further image may be prepared in a similar manner to the first and second images.

In some examples, the network status classification model may be trained comprising further training the network status classification model with the plurality of first images representing the measurements. Thus the model is trained with even more images, including the first images representing real measurements of the network parameters, and thus may be even more accurate or reliable.

In some examples, the trained network status classification model may be deployed to classify network status and anomalies, for example cell traffic load in the whole network—i.e. predict for each cell and/or the whole network a corresponding issue, anomaly or problem category—in a relatively short time. As an example, 200,000 cells in a network may be classified (e.g. their status classified) in less than 20 minutes. Thus, embodiments of the present disclosure may contribute towards automation for communications networks, including wireless communications networks. In addition, in some examples, once an issue is detected by the trained model, detailed root cause analysis can be provided based on the issue, and potential remedial actions to be implemented in the network may be suggested. In an example, a cell in a network may have two cell traffic load issues at the same time (e.g. cell load and RACH access issue). The model may be able to detect both issues, and embodiments of the present disclosure may identify both the issues and root cause analysis accordingly. In some examples, these identifications may be used to implement remedial actions (e.g. remedial actions suggested by or determined as a result of the model) and verified through the resulting network performance, and may be fed back to the classifier system to improve the prediction accuracy.

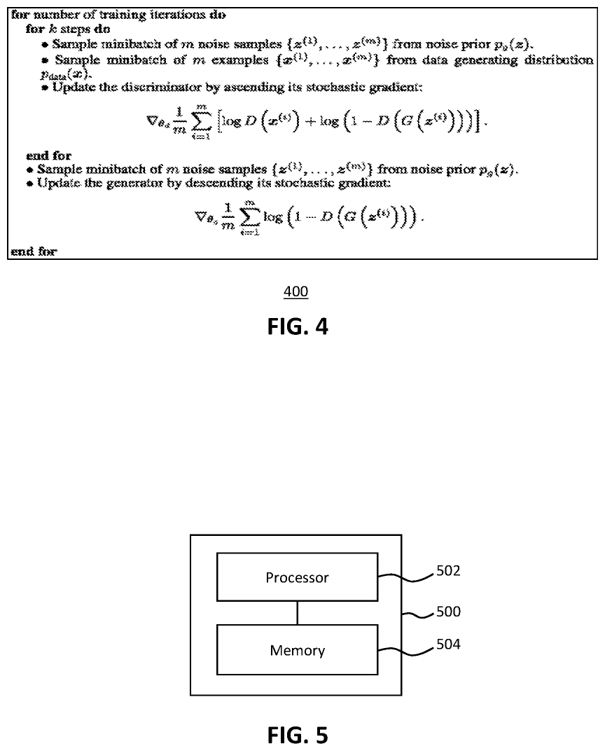

FIG. 5 is a schematic of an example of apparatus 500 for training a network status classification model. The apparatus 500 comprises processing circuitry 502 (e.g. one or more processors) and a memory 504 in communication with the processing circuitry 502. The memory 504 contains instructions executable by the processing circuitry 502. In one embodiment, the memory 504 contains instructions executable by the processing circuitry 502 such that the apparatus 500 is operable to obtain measurements of network parameters of a communications network, convert the measurements into a plurality of first images representing the measurements, train a deep convolutional generative adversarial network, DCGAN, with the images, generate a plurality of second images representing artificial measurements of the network parameters using the DCGAN, and train a network status classification model with the plurality of second images. In some embodiments, the memory 504 contains instructions executable by the processing circuitry 502 such that the apparatus 500 is operable to carry out the method 100 as described above.

It should be noted that the above-mentioned examples illustrate rather than limit the invention, and that those skilled in the art will be able to design many alternative examples without departing from the scope of the appended statements. The word “comprising” does not exclude the presence of elements or steps other than those listed in a claim or embodiment, “a” or “an” does not exclude a plurality, and a single processor or other unit may fulfil the functions of several units recited in the statements below. Where the terms, “first”, “second” etc are used they are to be understood merely as labels for the convenient identification of a particular feature. In particular, they are not to be interpreted as describing the first or the second feature of a plurality of such features (i.e. the first or second of such features to occur in time or space) unless explicitly stated otherwise. Steps in the methods disclosed herein may be carried out in any order unless expressly otherwise stated. Any reference signs in the statements shall not be construed so as to limit their scope.

### REFERENCES

The following references are incorporated herein by reference.
[1] Alec Radford & Luke Metz, “Unsupervised Representation Learning With Deep Convolutional Generative Adversarial Networks”, 2016
[2] Ian Goodfellow, Yoshua Bengio et al, “Generative Adversarial Nets”, June 2014
[3] Karteek Alahari, Konstantin Shmelkov and Cordelia Schmid, “How good is my GAN?”, July 2018
[4] Ian Goodfellow, Tim Salimans et al, “Improved Techniques for Training GANs”, June 2016

1. A method of training a network status classification model, the method comprising:
obtaining measurements of network parameters of a communications network;
converting the measurements into a plurality of first images representing the measurements;
training a deep convolutional generative adversarial network, DCGAN, with the first images;
generating a plurality of second images representing artificial measurements of the network parameters using the DCGAN; and
training a network status classification model with the plurality of second images.

2. The method of claim 1, comprising further training the DCGAN with the plurality of first images representing the measurements.

3. The method of claim 1, wherein each of the first images is associated with a respective network status of the network from a plurality of network statuses, and wherein generating the plurality of second images comprises generating a respective artificial network status associated with each of the second images.

4. The method of claim 1, comprising, after training the DCGAN, evaluating the DCGAN, wherein evaluating the DCGAN comprises:
training a further network status classification model with the plurality of second images;
providing one or more of the first images to the further network status classification model to provide, for each of the one or more first images, a respective estimated network status of the network; and
comparing the network status and the estimated network status associated with each of the one or more first images.

5. The method of claim 1, comprising, after training the DCGAN, evaluating the DCGAN, wherein evaluating the DCGAN comprises:
training a further network status classification model with the plurality of first images;
providing one or more of the second images to the further network status classification model to provide, for each of the one or more second images, a respective estimated artificial network status of the network; and
comparing the artificial network status and the estimated artificial network status associated with each of the one or more second images.

6. The method of claim 3, wherein at least one of the plurality of network statuses comprises a network fault status.

7. The method of claim 1, comprising classifying a status of the network based on further measurements of the network parameters.

8. The method of claim 7, wherein classifying the status of the network comprises converting the further measurements into a further image representing the further measurements, and providing the further image to the network status classification model to provide a status of the network.

9. The method of claim 1, wherein the network status model comprises an image recognition model.

10. The method of claim 1, wherein the network parameters comprise a plurality of network performance indicators, and/or one or more of a PUSCH interference level, PUCCH interference level, an average Channel Quality Indicator, CQI, and a rate of a CQI below a predetermined value received at a node in the network.

11-12. (canceled)

13. A computer program product comprising non transitory computer readable medium having stored thereon a computer program comprising instructions which, when executed on at least one processor, cause the at least one processor to carry out a method according to claim 1.

14. An apparatus for training a network status classification model, the apparatus comprising a processor and a memory, the memory containing instructions executable by the processor such that the apparatus is operable to:
obtain measurements of network parameters of a communications network;
convert the measurements into a plurality of first images representing the measurements;
train a deep convolutional generative adversarial network, DCGAN, with the first images;
generate a plurality of second images representing artificial measurements of the network parameters using the DCGAN; and
train a network status classification model with the plurality of second images.

15. The apparatus of claim 14, wherein the memory contains instructions executable by the processor such that the apparatus is operable to further train the DCGAN with the plurality of first images representing the measurements.

16. The apparatus of claim 14, wherein each of the first images is associated with a respective network status of the network from a plurality of network statuses, and wherein the memory contains instructions executable by the processor such that the apparatus is operable to generate the plurality of second images by generating a respective artificial network status associated with each of the second images.

17. The apparatus of claim 14, wherein the memory contains instructions executable by the processor such that the apparatus is operable to, after training the DCGAN, evaluate the DCGAN, wherein evaluating the DCGAN comprises:
training a further network status classification model with the plurality of second images;
providing one or more of the first images to the further network status classification model to provide, for each of the one or more first images, a respective estimated network status of the network; and
comparing the network status and the estimated network status associated with each of the one or more first images.

18. The apparatus of claim 14, wherein the memory contains instructions executable by the processor such that the apparatus is operable to, after training the DCGAN, evaluate the DCGAN, wherein evaluating the DCGAN comprises:
training a further network status classification model with the plurality of first images;
providing one or more of the second images to the further network status classification model to provide, for each of the one or more second images, a respective estimated artificial network status of the network; and
comparing the artificial network status and the estimated artificial network status associated with each of the one or more second images.

19. (canceled)

20. The apparatus of claim 14, wherein the memory contains instructions executable by the processor such that the apparatus is operable to classify a status of the network based on further measurements of the network parameters.

21. The apparatus of claim 20, wherein the memory contains instructions executable by the processor such that the apparatus is operable to classify the status of the network by converting the further measurements into a further image representing the further measurements, and providing the further image to the network status classification model to provide a status of the network.

22. (canceled)

23. The apparatus of claim 14, wherein the network parameters comprise a plurality of network performance indicators, and/or one or more of a PUSCH interference level, PUCCH interference level, and an average Channel Quality Indicator, CQI, and a rate of a CQI below a predetermined value received at a node in the network.

24. An apparatus for training a network status classification model, wherein the apparatus is configured to:
obtain measurements of network parameters of a communications network;
convert the measurements into a plurality of first images representing the measurements;
train a deep convolutional generative adversarial network, DCGAN, with the first images;
generate a plurality of second images representing artificial measurements of the network parameters using the DCGAN; and
train a network status classification model with the plurality of second images.
